(19) United States
(12) Patent Application Publication
(10) Pub. No.: US 2002/0101428 A1
(43) Pub. Date: Aug. 1, 2002

(54) Graphic engine and method for reducing idle time by validity test

(75) Inventors: Chien-chung Hsiao, Pai Sha Hsiang (TW); Kwo-woei Yet, Tou Fen Chen (TW); Chung-yung Lee, Taipei (TW)

Correspondence Address: BACON & THOMAS, PLLC, 625 SLATERS LANE, FOURTH FLOOR, ALEXANDRIA, VA, 22314

(73) Assignee: Silicon Integrated Systems Corp., Hsinchu (TW)

(21) Appl. No.: 10/055,959

(22) Filed: Jan. 28, 2002

(30) Foreign Application Priority Data
Jan. 29, 2001 (TW) 90101726

(51) Int. Cl. G09G 5/399; G09G 5/36; G06T 1/20

(52) U.S. Cl. 345/539; 345/558; 345/506

(57) ABSTRACT

The invention provides a graphic engine and a method that reduces the idle time of the graphic engine by validity test. The validity test is performed when the back buffer is full and the graphic engine continues to write a primitive into a front buffer. The validity test compares the maximum Y-coordinate of the primitive with the Y-coordinate of the current scan line. If the maximum Y-coordinate of the primitive is less than the Y-coordinate of the current scan line, the graphic engine keeps on executing the primitive processing procedure. On the other hand, if the maximum Y-coordinate of the primitive is greater than or equal to the Y-coordinate of the current scan line, the graphic engine halts the primitive processing procedure until the maximum Y-coordinate of the primitive is less than the Y-coordinate of the current scan line.

### BACKGROUND OF THE INVENTION

1. Field of the Invention

The invention relates to a graphic engine and a method that reduces the idle time of the graphic engine and, more particularly, to a graphic engine and a method that performs a validity test to optimize the usage of a front buffer, thereby reduce the idle time of the graphic engine.

2. Description of the Related Art

The 3D graphic system often uses the pipeline design technique to increase the drawing speed and improve the quality. As shown in FIG. 1, the pipeline for a conventional 3D graphic engine can be divided into 4 steps: setup, scan, color processing, and texture processing. The graphic engine includes a command queue 10, a setup engine 11, a scan converter 12, a color calculator 13, a texture pipeline unit 14, a depth test unit 15, a memory controller 16, an alpha blending unit 17, and a display controller 18. The setup engine 11 is for primitive initialization, the scan converter 12 for obtaining pixel coordinates, and the color calculator 13 for color rendering. Moreover, the texture pipeline unit 14 is for handling image textures, the depth test unit 15 is to remove the hidden surface plane, and the alpha blending unit 17 is for producing transparent and translucent effects. Furthermore, the display controller 18 is to display correctly the image onto a screen. The 3D graphic engine receives and executes drawing commands stored in the command queue 10. The command queue 10, being a first in first out (FIFO) unit, stores information of drawing commands transmitted from a controller 9 through the system bus.

As shown in FIG. 2, the display controller 18 of FIG. 1 sends primitives, which are stored in a front buffer 22, to a monitor 21 according to the sequence of left to right and top to bottom. At the same time, new primitives are perpetually processed by a graphic engine, and are written into a back buffer 23 (also called off-screen buffer) of the graphics memory.

FIG. 3A shows the technique of double buffering with a front buffer and a back buffer in a graphics memory. The data stored in the front buffer in memory region A of the graphics memory are the image data currently displayed on the screen. The next image to be shown is stored in the back buffer in the memory region B of the graphics memory. In 3D application software, the next image to be shown on the screen is usually written into a back buffer in the memory. After the writing is finished, if the image data stored in the front buffer have been fully read and displayed onto the screen, a “flip page” command will be issued. At the time, the back buffer in memory region B is switched to become the front buffer, and the image stored in this region is then displayed onto the screen. Meanwhile, the front buffer of the memory region A, whose associated data have been fully read, becomes the back buffer. This is an important technique used in programs for multimedia, animations and games, and is called double buffering. If the image to be displayed has been completely written into the back buffer, but the image data stored in the front buffer has not been fully displayed on the screen, the command queue promptly stops sending any commands to the graphic engine. The graphic engine halts the operation until the system receives a vertical blank signal of the screen and sends a flip-page command, then the processing of image data is resumed. Before this, the graphic engine remains in an idle state. Consequently, the working efficiency of the graphic engine is deteriorated.

FIG. 3B shows the technique of triple buffering with a front buffer and two back buffers in a graphics memory. As shown in FIG. 3B, a cyclic way of using a front buffer and two back buffers is utilized to reduce the idle time of a graphic engine. In this way, the idle time of a graphic engine may be further reduced. However, the costs of the memory, such as SDRAM, SGRAM, or other types of random access memory, used for the buffers are high. Therefore, it cannot be avoided that the triple buffering architecture has the drawback of high cost.

### SUMMARY OF THE INVENTION

In view of the above-mentioned drawbacks of the prior art graphic engines, the object of the invention is to provide a graphic engine and a method that performs a validity test to optimize the usage of a front buffer. The idle time of the graphic engine thus can be reduced.

According to one aspect of the invention, a validity test is executed in a setup engine. The validity test compares the Y-coordinate of the current scan line with the maximum Y-coordinate of the primitive to be drawn next. If the comparison result is that the Y-coordinate of the current scan line is greater than the maximum Y-coordinate of the primitive, the graphic engine keeps on executing the primitive processing procedure. On the other hand, if the Y-coordinate of the current scan line is less than or equal to the maximum Y-coordinate of the primitive, the graphic engine halts the primitive processing procedure. The graphic engine then keeps on performing the validity test until the Y-coordinate of the current scan line is greater L than the maximum Y-coordinate of the primitive to be drawn. In this way, the phenomenon of primitive overlap can be avoided.

According to another aspect of the invention, a validity test is executed in an external memory controller. The validity test judges whether the memory region where the primitive of the drawing command is to be written into overlaps the memory region occupied by another primitive which has been written into the front buffer and not yet displayed. If the former memory region does not overlap the latter memory region, the graphic engine keeps on executing the primitive processing procedure. On the other hand, if the former memory region overlaps the latter memory region, the graphic engine halts the primitive processing procedure. The graphic engine then keeps on performing the test until the image data stored in the memory address required for the next primitive have been fully read. In this way, the phenomenon of primitive overlap can be avoided as well.

### BRIEF DESCRIPTION OF THE DRAWINGS

FIG. 1 is a simplified block diagram of a conventional 3D graphic engine.

FIG. 2 is a schematic diagram showing simultaneous actions of flip page and vertical blank signal.

FIG. 3A and FIG. 3B are simplified diagrams illustrating the double buffering technique and triple buffering technique respectively.

FIG. 4A and FIG. 4B are schematic diagrams showing the corresponding positions on the screen of the primitive of the drawing commands executed by a setup engine.

FIG. 5 is a block diagram showing a preferred embodiment of the graphic engine in accordance with the present invention.

FIG. 6 is a flow chart of the validity test performed by the graphic engine of FIG. 5.

FIG. 7 is a block diagram showing another preferred embodiment of the graphic engine in accordance with the present invention.

FIG. 8 is a flow chart of the validity test performed by the graphic engine of FIG. 6.

### DESCRIPTION OF THE PREFERRED EMBODIMENT

The preferred embodiments of the present invention are illustrated with reference to the accompanying drawings.

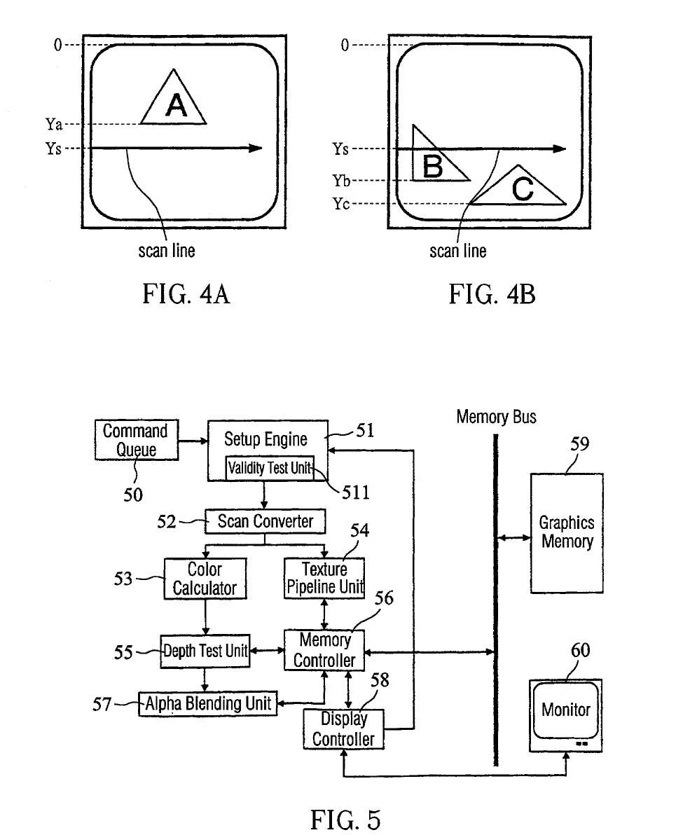

FIG. 4A and FIG. 4B are schematic diagrams showing the corresponding positions on the screen of the primitive of the drawing command executed by a setup engine. As shown in FIG. 4A, the maximum Y-coordinate Yₐ of the primitive A, is less than the scan line's Y-coordinate Ys. Therefore, writing the primitive A of the drawing command into a front buffer does not affect the current display screen. On the other hand, the maximum Y-coordinates of the primitives B and C shown in FIG. 4B, Y_{b} and Y_{c} respectively, are greater than the Y-coordinate Ys of the scan line. If the primitives B and C of drawing commands are written into a front buffer, the appearance of the current primitive which has not yet been displayed on the screen will be affected. In view of the above, “validity test” is defined as follows: (1) If the maximum Y-coordinate of the primitive of a drawing command is less than the Y-coordinate of a current scan line, the drawing command passes the validity test; (2) If the maximum Y-coordinate of the primitive of a drawing command is greater than or equal to the Y-coordinate of a current scan line, the drawing command does not pass the validity test. When there is no back buffer available, the validity test can be performed and the result can be used to determine whether to execute a primitive processing procedure perpetually. Specifically, if a drawing command passes the validity test, then the drawing command can be executed perpetually and the executed result can be saved in a front buffer. On the other hand, if a drawing command does not pass the validity test, then the drawing command must be halted until the drawing command passes the validity test. In this way, one can effectively utilize the front buffer.

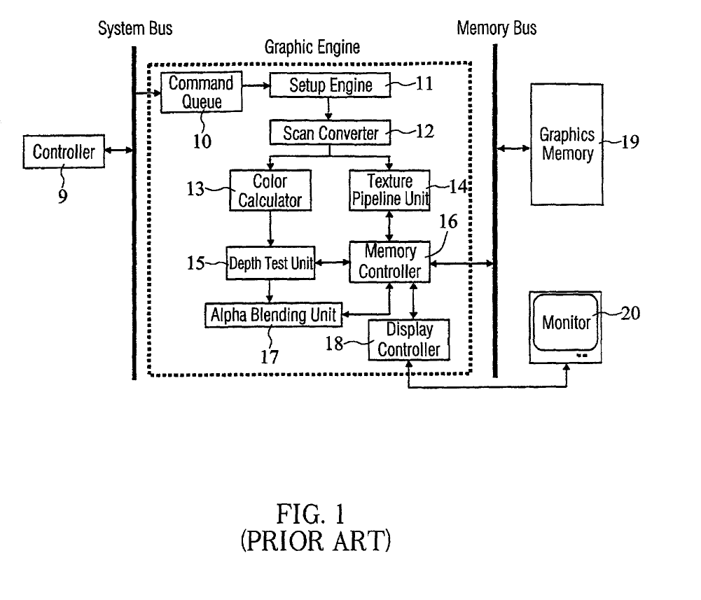

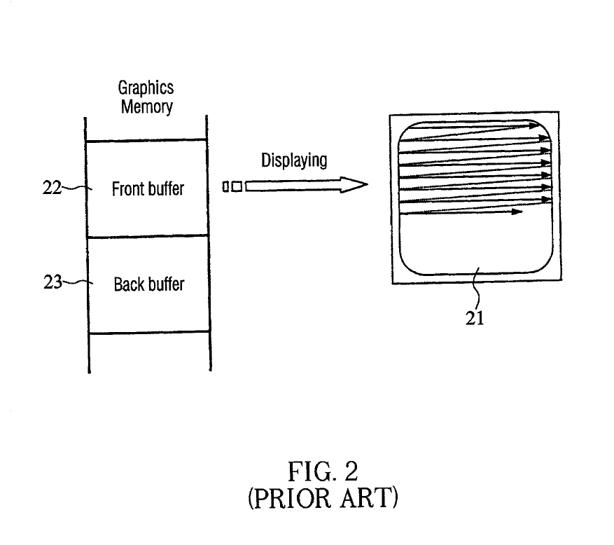

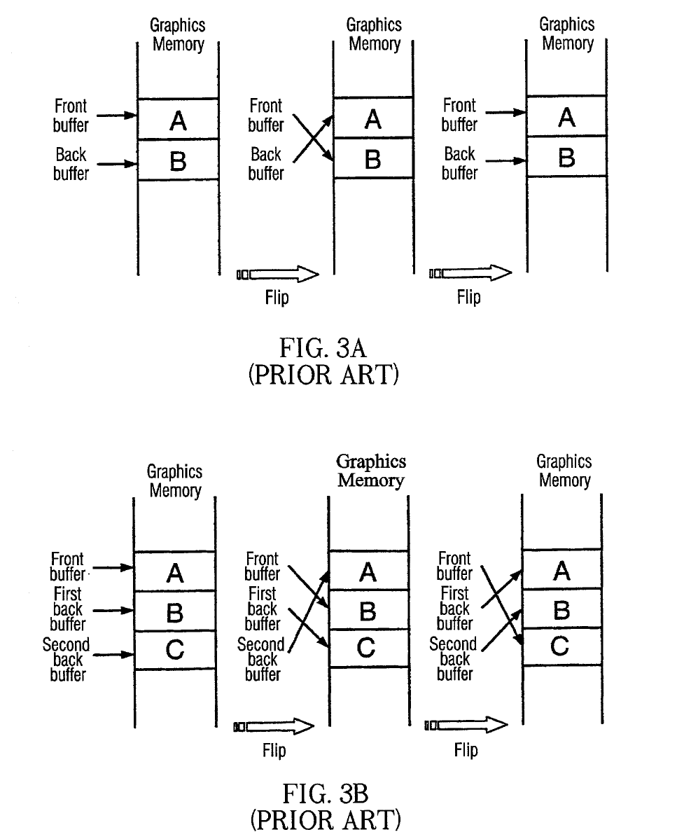

FIG. 5 shows a preferred embodiment of the graphic engine in accordance with the present invention. The graphic engine illustrated by FIG. 5, similar to the conventional graphic engine illustrated by FIG. 1, includes a command queue 50, a setup engine 51, a scan converter 52, a color calculator 53, a texture pipeline unit 54, a depth test unit 55, a memory controller 56, an alpha blending unit 57 and a display controller 58. These units function in a similar way as the corresponding units of the conventional graphic engine shown in FIG. 1. The descriptions about similar portions are thus omitted here. Compared to the graphic engine as shown in FIG. 1, the graphic engines as shown in FIG. 5 is characterized in that an additional validity test unit 511 is installed in the setup engine 51 in order to determine if a primitive can be written into a front buffer.

After the command queue 50 issues a drawing command to the setup engine 51, if the drawing command is to write a primitive into a back buffer, the validity test is skipped and the drawing command is carried out without interruption. However, if the back buffer is full, and the primitive of the drawing command must be written into a front buffer, the setup engine 51 performs a validity test, which is described as follows. First, the setup engine reads the Y-coordinate of the current scan line from the display controller 58. If the maximum Y-coordinate of the primitive is greater than the Y-coordinate of the current scan line, the drawing command does not pass the validity test, the graphic engine halts the primitive processing procedure and keeps on performing the validity test until the maximum Y-coordinate of the primitive is smaller than the Y-coordinate of the current scan line. On the other hand, if the maximum Y-coordinate of the primitive is less than or equal to the Y-coordinate of the current scan line, the drawing command passes the validity test. The setup engine 51 issues the drawing command to the next pipeline, for example, the scan converter 52, to further proceed with the drawing command and write the result into the front buffer.

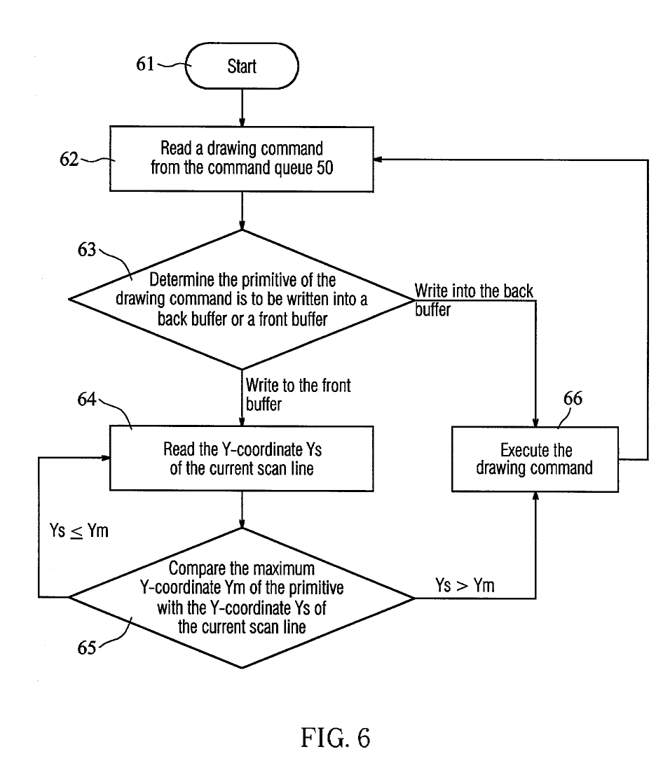

FIG. 6 is a flow chart of the validity test performed by the graphic engine of FIG. 5. The testing steps are described as follows.

Step 61: Start;

Step 62: Read a drawing command from the command queue 50;

Step 63: Determine the primitive of the drawing command is to be written into a back buffer or a front buffer. If the primitive is to be written into a back buffer, go to Step 66; otherwise go to Step 64;

Step 64: Read the Y-coordinate Ys of the current scan line;

Step 65: Compare the maximum Y-coordinate Ym of the primitive with the Y-coordinate Ys of the current scan line. If Ys>Ym, go to Step 66; otherwise go to Step 64;

Step 66: Execute the drawing command and go to Step 62.

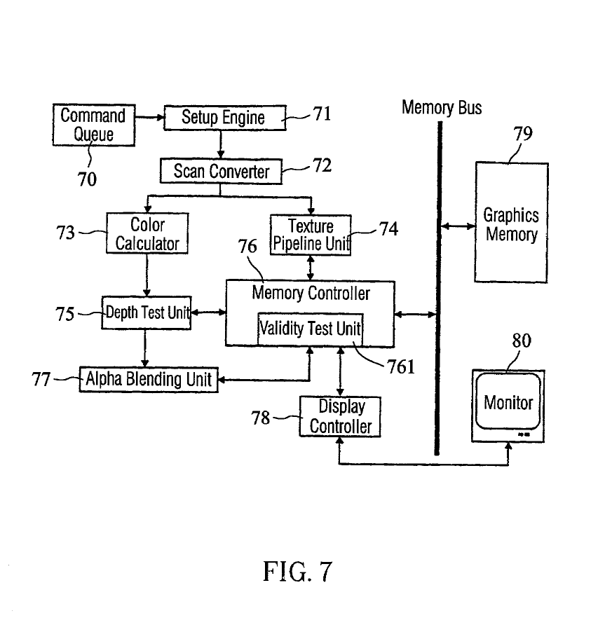

FIG. 7 shows another preferred embodiment of the graphic engine in accordance with the present invention. The graphic engine as shown is similar to that shown in FIG. 5. The difference between them is that the validity test unit here is installed in a memory controller 76 instead of setup engine. Specifically, the graphic engine of FIG. 5 performs a validity test in the setup engine 51 of the graphic engine. It compares the maximum Y-coordinate of the primitive and the Y-coordinate of the current scan line. On the other hand, the graphic engine of FIG. 7 performs the validity test in the memory controller 76, which compares memory addresses as explained hereinafter.

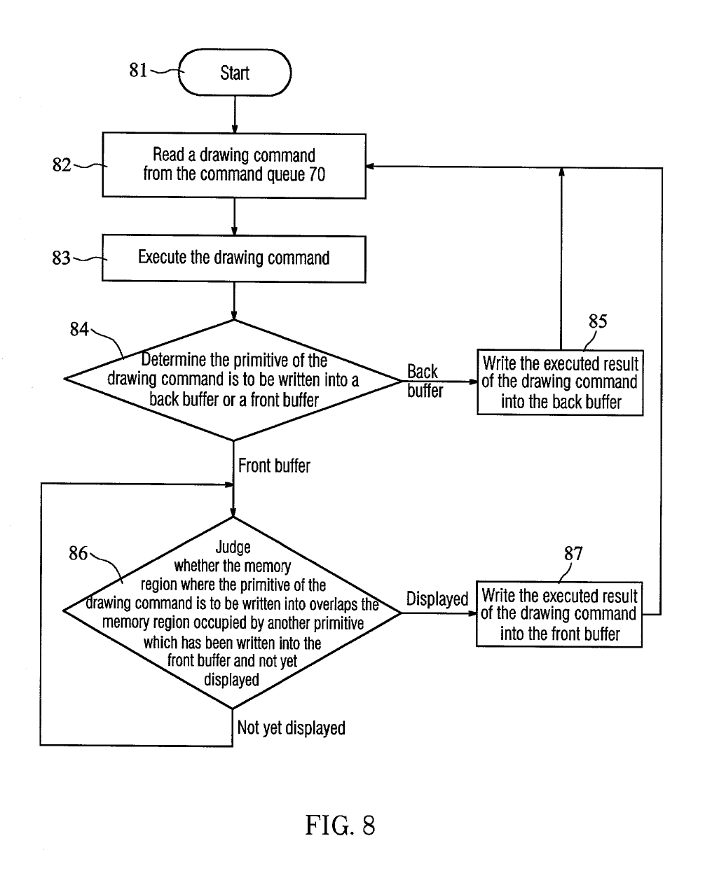

FIG. 8 is a flow chart of the validity test performed by the graphic engine of FIG. 7. The testing steps are described as follows.

Step 81: Start;

Step 82: Read a drawing command from the command queue 70;

Step 83: Execute the drawing command;

Step 84: Determine the primitive of the drawing command is to be written into a back buffer or a front buffer; if the primitive is to be written into a back buffer, go to Step 85; otherwise go to Step 86;

Step 85: Write the executed result of the drawing command into the back buffer and go to Step 82;

Step 86: Judge whether the memory region where the primitive of the drawing command is to be written into overlaps the memory region occupied by another primitive which has been written into the front buffer and not yet displayed, if YES, repeat Step 86; otherwise, go to the Step 87;

Step 87: Write the executed result of the drawing command into the front buffer and go to Step 82.

In summary, the invention reduces the idle time of a graphic engine, speeds up the image processing and effectively optimizes the current resources available to maximize the economic benefits.

While there have been shown and described what are at present considered the preferred embodiments of the invention, it will be obvious to those skilled in the art that various changes and modifications may be made therein without departing from the scope of the invention as defined by the appended claims.

What is claimed is:

1. A graphic engine that uses a validity test for verifying the validity of a drawing command in order to reduce the idle time of the graphic engine comprising:
a command queue;
a setup engine for receiving a drawing command transmitted from the command queue to perform the validity test;
a scan converter for receiving and processing the drawing command from the setup engine;
a display controller for providing the setup engine with the Y-coordinate of a current scan line; and
a validity test unit for verifying the validity of the drawing command when a back buffer is full and writing the primitive of the drawing command into a front buffer if the drawing command passes the validity test.

2. The graphic engine of claim 1, wherein the validity test unit is installed within the setup engine.

3. The graphic engine of claim 2, wherein the validity test unit compares the Y-coordinate of the current scan line with the maximum Y-coordinate of the primitive; if the Y-coordinate of the current scan line is greater than the maximum Y-coordinate of the primitive, then the drawing command passes the validity test.

4. The graphic engine of claim 1, wherein the validity test unit is installed within an external memory controller.

5. The graphic engine of claim 4, wherein the validity test unit compares the memory address of the next primitive to be drawn with the memory address of the primitive which has been read in the front buffer, if the former is smaller than the latter, the drawing command passes the validity test.

6. A method for performing a validity test of a drawing command to reduce the idle time of a graphic engine comprising the steps of:
(a) reading a drawing command from a command queue;
(b) determining the primitive of the drawing command is to be written into a back buffer or a front buffer, if the primitive is to be written into a back buffer, the drawing command is executed, then go to step (a); otherwise, go to step (c);
(c) performing the validity test for the drawing command to determine whether a new primitive overlaps a primitive stored in the front buffer and not yet displayed; if overlap does not occur, the drawing command passes the validity test and is executed, then go to step (a); otherwise keeps on performing the validity test.

7. The method of claim 6, wherein step (c) comprises the steps of:
reading the Y-coordinate of a current scan line; and
comparing the Y-coordinate of the current scan line with the maximum Y-coordinate of the primitive to be drawn; if the Y-coordinate of the current scan line is greater than the maximum Y-coordinate of the primitive, the drawing command passes the validity test.

8. The method of claim 6, wherein step (c) comprises the steps of:
judging whether the memory region where the primitive of the drawing command is to be written into overlaps the memory region occupied by another primitive which has been written into the front buffer and not yet displayed.
